(19) United States
(12) Patent Application Publication
(10) Pub. No.: US 2020/0253130 A1
(43) Pub. Date: Aug. 13, 2020

(54) The Harvest Zone

(71) Applicant: Tariq Williams, Downey, CA (US)

(72) Inventor: Tariq Williams, Downey, CA (US)

(21) Appl. No.: 16/780,846

(22) Filed: Feb. 3, 2020

Related U.S. Application Data
(60) Provisional application No. 62/918,533, filed on Feb. 4, 2019.

(51) Int. Cl. A01G 9/02; A01G 9/24

(52) U.S. Cl. CPC A01G 9/023; A01G 9/249; A01G 9/247

(57) ABSTRACT

The Harvest Zone is a vertical farming solution designed for an angle of ninety degrees. It is comprised of attachable LED lights, attachable grow containers, and a ninety degree vertical triangular prism which distributes both electrical and water supply. The LED grow lights are attached to designable grow containers, the designable containers are attached to the ninety degree triangular prism which is made to fit a ninety degree structure.

### BACKGROUND

In 1911, V. M. Artsikhovski published in the journal “Experienced Agronomy” an article “On Air Plant Cultures”, which talks about his method of physiological studies of root systems by spraying various substances in the surrounding air—the aeroponics method. He designed the first aeroponics and in practice showed their suitability for plant cultivation. It was W. Carter in 1942 who first researched air culture growing and described a method of growing plants in water vapor to facilitate examination of roots. [10] As of 2006, aeroponics is used in agriculture around the globe.[11] In 1944, L. J. Klotz was the first to discover vapor misted citrus plants in a facilitated research of his studies of diseases of citrus and avocado roots. In 1952, G. F. Trowel grew apple trees in a spray culture.[6] It was F. W. Went in 1957 who first coined the air-growing process as “aeroponics”, growing coffee plants and tomatoes with air-suspended roots and applying a nutrient mist to the root section.[6]

### Reference:

https://en.m.wikipedia.org/wiki/Aeroponics#History

### BRIEF SUMMARY

The Harvest Zone is a vertical farming solution designed for an angle of ninety degrees. The advantages of this product is that its compact, modular, has designable parts, and has peer to peer farmers market location feature in the control module.

### BRIEF DESCRIPTIOIN OF DRAWING

FIG. 1) nutrient water tank and pump reservoir. The nutrient water tank and pump reservoir will contain nutrient water supply along with a high pressure pump to deliver nutrient mist or water to the plant root system.

FIG. 2) is the control module. The control module indicates water tank levels, lighting timers, pH values, misting timers, pump timer, and contain an app which will allow other purchasers of the product to locate one another.

FIG. 3) the hook apparatus where are the grow containers attached to the product.

FIG. 4) high pressure water nozzles and or nutrient water delivery to root system.

FIG. 5) is the “spine” and or vertical electrical and nutrient water delivery rail which is designed to fit an angle of 90 degrees.

FIG. 6) positive electrical terminal.

FIG. 7) negative electrical terminal

FIG. 8) grow container which attaches FIG. #5.

FIG. 9) shows net pots. Hydro Stone or a growing root medium will be put into the net pots to serve as a medium some grow from seed to plant.

FIG. 10) grow lights which are attachable to FIG. #8

FIG. 11) hook on the back of a grow container

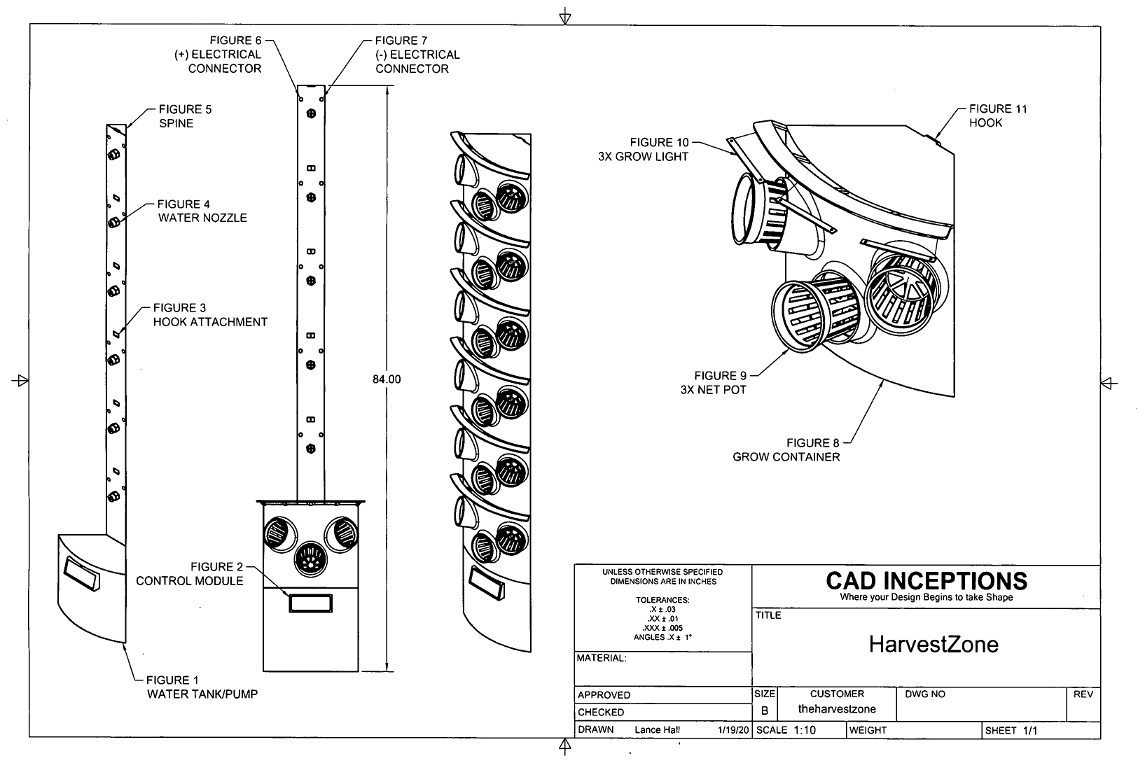

### DETAILED DESCRIPTION OF INVENTION

The Harvest Zone is an indoor vertical farming solution comprised of a water tank which can house a pump or aquaponic fish tank. a control module. hook and/click attachment on the said “spine.” water nozzles. A “spine” which distributes electrical and water source supply. Designable grow containers. Net pots. Designable LED grow lights. The specific improvements made by The Harvest Zone is that it's compact, modular, features a ninety degree vertical triangular prism (“spine”) that allows designable grow containers to be attached to it. Another improvement is the app/control module which allows users to locate one another for peer to peer farmers markets. Not only is the product compact, it will also have the ability to create community.

I Tariq Williams claim,

1. The Harvest Zone is a vertical farming solution comprising of :
a. Designable vertical ninety degree triangular prism “spine”
b. Designable grow container attachments
c. Designable led light attachments
The said “spine” contains a water source (in middle,) a negative (on left) and positive (on right) electrical leads encased in a vertical triangular prism or said “spine.”
The designable grow containers house root systems and intake water supply once attached to the said “spine.”
The designable LEDs light up on contact once attached to the said “spine.”
